(19) United States
(12) Patent Application Publication
(10) Pub. No.: US 2025/0326918 A1
(43) Pub. Date: Oct. 23, 2025

(54) POLYCHLOROPRENE ELASTOMER CURED BY SUSTAINABLE VULCANIZING AGENT

(71) Applicant: ContiTech Deutschland GmbH, Hannover (DE)

(72) Inventors: Guangzhuo Rong, Hudson, OH (US); Vincent Rigaut, Montreal (CA)

(73) Assignee: ContiTech Deutschland GmbH, Hannover (DE)

(21) Appl. No.: 18/640,390

(22) Filed: Apr. 19, 2024

(51) Int. Cl. C08L 11/00; B32B 1/08; B32B 3/04; B32B 3/08; B32B 3/30; B32B 5/02; B32B 5/26; B32B 25/02; B32B 25/08; B32B 25/10; B32B 27/08; B32B 27/12; B32B 27/30; B32B 27/34; F16L 11/04; F16L 11/08

(52) U.S. Cl. CPC C08L 11/00; B32B 1/08; B32B 3/04; B32B 3/085; B32B 3/30; B32B 5/02; B32B 5/26; B32B 25/02; B32B 25/08; B32B 25/10; B32B 27/08; B32B 27/12; B32B 27/304; B32B 27/34; F16L 11/086; B32B 2260/046; B32B 2264/108; B32B 2274/00; B32B 2307/536; B32B 2307/54; B32B 2307/554; B32B 2307/5825; B32B 2433/02; B32B 2433/04; B32B 2581/00; B32B 2597/00; C08L 2203/18; C08L 2312/00; F16L 2011/047

(57) ABSTRACT

An article such as a multilayer hose includes at least one layer formed from an elastomeric composition including one or more polychloroprene elastomer(s); and a sustainable vulcanizing agent adapted to cure the one or more polychloroprene elastomer(s), the sustainable vulcanizing agent being at least partially derived from a sustainable source of treated dregs, and having a composition comprising, in % by mass based on the sustainable vulcanizing agent: 25%-50% CaO, 2% to 20% MgO, and 20% to 40% ZnO.

### TECHNICAL FIELD

The present disclosure relates generally to a polychloroprene elastomer cured by a sustainable vulcanizing agent, and also to elastomeric article(s), such as multilayer hose, at least partially formed from such sustainable vulcanizing agent-cured polychloroprene elastomer.

### BACKGROUND

Elastomers are used across numerous industries due to their elasticity, resilience, and impermeability. Polychloroprene elastomer, for example, offers these characteristics, as well as notable features in terms of chemical resistance, weather resistance, heat resistance, etc. This allows polychloroprene elastomer to be used in a wide variety of industries, including products such as industrial and automotive hoses, power transmission belts, conveyor belts, air spring bellows, dampers, seals, gaskets, and more.

### SUMMARY

There is a continuing trend in the elastomer industry to improve sustainability by using sustainable raw materials. An example of this is found in U.S. Publication No. 2022/0034033 by Scodro, which discloses a process for treating dregs, which is a residue generated in the cellulose industry during the Kraft process, and using the treated dregs as a vulcanization activator for natural rubber, styrene butadiene rubber (SBR), ethylene-propylene diene rubber (EPDM), polybutadiene rubber (BR), or nitrile rubber (NBR). Specifically, the U.S. Publication by Scodro uses the treated dregs to reduce or eliminate the common rubber activator zinc oxide (ZnO), in which these treated dregs are used in conjunction with conventional sulfur vulcanizing agent to cure the rubber.

Through experimentation with such sustainable dreg material, the present inventors surprisingly found that it can be used not only as an activator for those rubbers disclosed in Scodro, but also can be used in a sustainable vulcanizing agent to reduce the overall amount of ZnO used to vulcanize the polychloroprene elastomer. Even more surprising was the discovery that when the treated dregs were used in a sustainable vulcanizing agent that further included a relatively small amount of zinc oxide to cure polychloroprene elastomer, this sustainable vulcanizing agent exhibited a synergistic effect that performed almost the same in terms of rheometric cure behavior and physical properties as a comparative polychloroprene composition having almost three times as much ZnO.

Accordingly, at least one aspect of the present disclosure provides a multilayer hose including: an inner tube layer; a reinforcement layer disposed outwardly from the inner tube layer; and an outer cover layer disposed outwardly from the reinforcement layer; wherein at least one of the inner tube layer, the reinforcement layer, and the outer cover layer is formed from an elastomeric composition comprising: one or more polychloroprene elastomer(s); and a sustainable vulcanizing agent adapted to cure the one or more polychloroprene elastomer(s), the sustainable vulcanizing agent being at least partially derived from a sustainable source of treated dregs, and having a composition comprising, in % by mass based on the sustainable vulcanizing agent: 25%-50% CaO, 2% to 20% MgO, and 20% to 40% ZnO.

According to another aspect, an article includes: at least one layer formed from an elastomeric composition including: one or more polychloroprene elastomer(s); and a sustainable vulcanizing agent adapted to cure the one or more polychloroprene elastomer(s), the sustainable vulcanizing agent being at least partially derived from a sustainable source of treated dregs, and having a composition comprising, in % by mass based on the sustainable vulcanizing agent: 25%-50% CaO, 2% to 20% MgO, and 20% to 40% ZnO.

According to another aspect, an elastomer-making process, includes at least the steps: providing an elastomeric mixture comprising one or more polychloroprene elastomer(s); and adding a sustainable vulcanizing agent to the elastomeric mixture, wherein the sustainable vulcanizing agent is adapted to cure the one or more polychloroprene elastomer(s), the sustainable vulcanizing agent being at least partially derived from a sustainable source of treated dregs, and having a composition comprising, in % by mass based on the sustainable vulcanizing agent: 25%-50% CaO, 2% to 20% MgO, and 20% to 40% ZnO.

The following description and the annexed drawings set forth certain illustrative embodiments according to the present disclosure. These embodiments are indicative, however, of but a few of the various ways in which the principles of the invention may be employed. Other objects, advantages and novel features according to aspects of the present disclosure will become apparent from the following detailed description when considered in conjunction with the drawings.

### BRIEF DESCRIPTION OF THE DRAWINGS

The annexed drawings, which are not necessarily to scale, show various embodiments according to the present disclosure.

FIG. 1 illustrates an exemplary article including an exemplary elastomeric composition according to the present disclosure.

FIG. 2A illustrates another exemplary article including an exemplary elastomeric composition according to the present disclosure.

FIG. 2B illustrates another exemplary article including an exemplary elastomeric composition according to the present disclosure.

FIG. 3 illustrates another exemplary article including an exemplary elastomeric composition according to the present disclosure.

FIG. 4 illustrates an exemplary multilayer hose including an exemplary elastomeric composition according to the present disclosure.

FIG. 5 illustrates another exemplary multilayer hose including an exemplary elastomeric composition according to the present disclosure.

FIG. 6 illustrates an exemplary conveyor belt including an exemplary elastomeric composition according to the present disclosure.

FIG. 7 illustrates another exemplary conveyor belt including an exemplary elastomeric composition according to the present disclosure.

FIG. 8 illustrates an exemplary power transmission belt including an exemplary elastomeric composition according to the present disclosure.

FIG. 9 illustrates another exemplary power transmission belt including an exemplary elastomeric composition according to the present disclosure.

FIG. 10 illustrates an exemplary air spring having a bellows including an exemplary elastomeric composition according to the present disclosure.

FIG. 11 illustrates the cure behavior of an exemplary G-type elastomeric composition versus a comparative G-type composition.

FIG. 12 illustrates the cure behavior of an exemplary W-type elastomeric composition versus a comparative W-type composition.

### DETAILED DESCRIPTION

The principles and aspects of the present disclosure have particular application to elastomeric materials containing polychloroprene elastomer, and also to articles at least partially formed from such elastomeric material, such as hoses, power transmission belts, conveyor belts, air spring bellows, dampers, seals, gaskets, or the like, and thus will be described herein chiefly in this context. It is understood, however, that the principles and aspects of the present disclosure may be applicable to other types of articles for other applications when desirable to provide one or more advantages of the material(s) and/or construction(s) described herein.

An aspect of the present disclosure improves the sustainability of polychloroprene elastomers and articles formed from such elastomers by using a sustainable vulcanizing agent derived from a sustainable source which is adapted to cure the polychloroprene elastomer, in particular the sustainable vulcanizing agent being at least partially derived from a sustainable source of treated dregs, as described in further detail below.

The term “sustainable” as used herein is in accordance with its ordinary and customary meaning. As such, a “sustainable material” is one in which that material or raw material(s) that make that material are from sustainable source(s). A sustainable source is a renewable source and/or a recycled source. A renewable source is one that can be replenished through sustainable practices, including, for example, natural or biomass materials, such as plant-based materials. A recycled source uses old material to reduce the demand of new raw materials. In general, sustainable materials reduce the negative impact on the environment, and thus generally are not derived from mining sources or petrochemical sources, including oil or natural gas, or the like. Treated dregs derived from processes such as cellulose production falls within the definition of sustainability by recycling and treating such dregs for reuse.

### Elastomeric Composition

The exemplary elastomeric composition according to the present disclosure includes one or more polychloroprene base elastomer(s) and a sustainable vulcanizing agent adapted to cure the one or more polychloroprene elastomer(s), in which the sustainable vulcanizing agent is at least partially derived from a sustainable source of treated dregs. The exemplary composition also may contain one or more of the following additional ingredients: one or more reinforcing agent(s), one or more plasticizer(s), one or more processing aid(s), one or more antidegradant(s), one or more accelerator(s), and optionally further suitable ingredient(s) to achieve desired characteristic(s). Such ingredients of the exemplary elastomeric composition will be described in further detail below for sake of clarity and not limitation, it being understood that certain embodiments may provide different suitable combinations of these ingredient types and/or amounts, may include one or more additional ingredients or alternative equivalent ingredients in any suitable combination, or may eliminate one or more of these ingredients in any suitable combination, as would be understood by those having ordinary skill in the art in view of the teachings provided herein. In addition, such ingredients of the exemplary elastomeric composition will be listed below under suitable subheadings for the sake of clarity, it being understood to those skilled in the art that some ingredients may serve multiple functions.

### Base Elastomer(s)

The one or more elastomer(s) of the composition form at least part of the matrix and serve as the base of the elastomeric composition. The composition also may contain other polymer(s), such as non-elastomer polymer(s), that are blended with the base elastomer(s) to also form part of the matrix of the composition. The total polymer content forming the base composition (including mixtures of base polymers) is set at 100 phr. The polymer matrix of the elastomeric composition generally will be formed from a majority of elastomer material(s) as opposed to other types of non-elastomer base polymer(s) to provide elastic properties, for example at least 80%, or at least 90% or more elastomer material(s) forming the polymer matrix. The additives in the composition are compounded relative to the total base polymer content of the composition, and as such may be represented in parts per hundred (phr), which means parts by weight per 100 parts by weight of the base polymer(s).

The exemplary elastomeric composition includes at least one polychloroprene elastomer (also referred to as polychloroprene rubber, or CR). Polychloroprene elastomer is a synthetic rubber that is derived from the polymerization of chloroprene monomer (2-chloro-1,3-butadiene). There are generally three types of polychloroprene elastomers: G-type, W-type, and T-type. The characteristics of G-type polychloroprene that differentiate it from W-type and T-Type is that G-type is sulfur-modified, typically derived from the copolymerization of chloroprene with sulfur, stabilized or modified with thiuram disulfide. G-types also typically have wider molecular weight distributions than W- or T-types. The W-type and T-type polychloroprene are not modified to have sulfur on the backbone and thus generally use an organic accelerator to provide a suitable cure rate. Within each type of polychloroprene there may be different grades providing different properties such as viscosity.

The elastomeric composition may include one or more types or grades of polychloroprene which may be selected alone or in any suitable combination for the particular application. In exemplary embodiments, the elastomeric composition is a polychloroprene-based composition, meaning that a large majority (e.g., 75% or greater of the polymer matrix is formed from one or more polychloroprene elastomers as opposed to other types of base polymers. In exemplary embodiments, the polychloroprene elastomer(s) constitute at least 75% by weight, more particularly at least 90% by weight, more particularly at least 95%, or at least 99%, or essentially 100% by weight (i.e., 100 phr) of the base polymer matrix of the elastomeric composition. For example, in certain embodiments in which a W-type is used, the polychloroprene elastomer(s) may constitute about 75% minimum by weight with optional other polymer(s) contributing to the base elastomer content that forms the matrix, and in other embodiments in which a G-type is used, the polychloroprene elastomer(s) may constitute about 100% by weight. In some embodiments, the polychloroprene elastomer(s) may be blended with other natural (NR) or synthetic rubbers. This may include, for example, styrene butadiene rubber (SBR), nitrile rubber (NBR), butyl rubber (IIR), ethylene propylene diene rubber (EPDM), or any other suitable rubber.

### Sustainable Vulcanizing Agent/Treated Dregs

The sustainable vulcanizing agent may include one or more materials derived from a sustainable source. In exemplary embodiments, at least part of the sustainable vulcanizing agent is derived from treated dregs, such as the type of treated dregs disclosed in U.S. Publication No. 2022/0034033 by Scodro, which is incorporated herein by reference in its entirety, and which certain descriptions thereof are provided below.

Dregs generally refers to a residue generated by the cellulose industry, in particular the residue generated in the clarification of the green liquor in the Kraft process of obtaining cellulose. Dregs residues result from the precipitation of a large number of non-procedural mineral elements (such as Al, Mg, Mn, Fe, Co, P, Si, Ca, Na), due to the strongly alkaline conditions in the medium, contained in the green liquor that comprises residues generated based on the incomplete burning of the black liquor, sodium carbonate (Na₂CO₃) and sodium sulfide (Na₂S). The resulting dregs are a dark-colored, pasty and slightly granular material, having a high pH varying from 11 to 13.

Dregs may include a mixture of alkaline and earthy alkaline metals, such as sodium, magnesium and calcium; metal cation-based oxides, such as aluminum; and transition metals, such as manganese, iron and cobalt. The composition of the dregs generated in the process of clarification of the green liquor, in % by mass based on the total mass of the composition of the dregs, may include major components of CaO from about 25% to about 50% and MgO from about 2% to about 20%. The dregs also may include other components, including, in % by mass based on the total mass of the composition of the dregs: Loss on Ignition (LOI): 35 to 45; SiO₂: 0.5 to 2.0; Al₂O₃: 0.5 to 1.5; Fe₂O₃: 0.5 to 1.5; TiO₂: 0.0 to 1.0; K₂O: 0.0 to 1.0; Na₂O: 0.5 to 5.0; P₂O₅: 0.2 to 1.5; BaO: 0.0 to 0.2; SrO: 0.0 to 0.5; MnO: 0.1 to 2.0; and SO₃: 0.5 to 5.0.

The process for treating dregs to make them suitable for use in elastomeric compositions may include the steps of (a) drying the dregs; and (b) micronizing the dregs to a suitable particle size. The drying may be carried out by any suitable process, such as with a rotary dryer, fluid bed dryer, or the like. The micronizing of the dregs may be carried out with any suitable process, such as with a mill, for example hammer mill, ball mill, or the like. Following these treating steps, the dregs have the same composition as described above.

The dregs may be micronized to an average particle size (d50) in a range from 2 to 45 micrometers. More particularly, the micronizing may be performed until the dregs reach an average particle size (d50) in a range from 4 to 15 micrometers, or more particularly from 4 to 10 micrometers. The smaller the size, the greater the surface area, and the greater the surface activity.

The sustainable vulcanizing agent may further include zinc oxide (ZnO). The zinc oxide may be added to the treated dregs, such as by admixing the zinc oxide with the dregs. The zinc oxide may have the same or similar size range as the treated dregs, such that the overall size of the vulcanizing agent mixed into the elastomeric mixture is in the same as the ranges described above.

In exemplary embodiments, the sustainable vulcanizing agent has a composition comprising 25%-50% CaO, 2% to 20% MgO, and 20% to 40% ZnO. More particularly, the sustainable vulcanizing agent may have a composition comprising: 25% to 35% CaO, 5% to 15% MgO, and 25% to 35% ZnO. Other minor constituents may be provided in the sustainable vulcanizing agent in accordance with the other materials present in the treated dregs as described above. An example of a material that was found to be suitable for use as the sustainable vulcanizing agent for polychloroprene is Oxi-Rubber Max P, marketed as a rubber activator by Oxitec, the assignee of the Scodro reference.

The sustainable vulcanizing agent may be provided in the elastomeric composition in any suitable amount for carrying out the vulcanization process of the elastomeric composition, and particularly the vulcanization of the polychloroprene elastomer(s) in the composition. In embodiments where the polychloroprene elastomer(s) are blended with other polymers, then sulfur may be added as an additional vulcanizing agent. In such embodiments with a blend, the sustainable vulcanizing agent including the treated dregs would serve as the vulcanizing agent for the polychloroprene elastomer(s) and also may serve as an activator for the other elastomer(s) in the mixture. In exemplary embodiments, however, when the elastomer(s) of the composition consist only of polychloroprene elastomer(s), the composition may contain only the sustainable vulcanizing agent to carry out the cure, such that no other vulcanizing agents are provided to cure the elastomeric composition (e.g., the composition is devoid of sulfur or peroxide vulcanizing agent).

In exemplary embodiments, the sustainable vulcanizing agent may be present in the elastomeric composition in a total amount from about 1 phr to about 10 phr, more particularly from about 3 phr to about 8 phr, such as about 5 phr, for example about 1, 2, 3, 4, 5, 6, 7, 8, 9 or 10 phr (including all values between the stated values and all ranges between such values). Thus, for example, a sustainable vulcanizing agent having a composition including 25% to 35% CaO, 5% to 15% MgO, and 25% to 35% ZnO and being present in the elastomeric composition at 5 phr would have about 1.25 phr ZnO to about 1.75 phr ZnO in the composition; and at 10 phr would have about 2.5 phr ZnO to about 3.5 phr ZnO in the composition. It is of course understood that these examples are not limiting, and the amounts of such ingredients (e.g., ZnO, MgO, CaO) in the elastomeric composition may vary based on the composition of the sustainable vulcanizing agent and its loading in the elastomeric composition, and thus may include all values and ranges based on such calculation.

As discussed further in the examples below, it was surprisingly found that such a sustainable vulcanizing agent with the above-noted ranges (e.g., 25% to 35% CaO, 5% to 15% MgO, and 25% to 35% ZnO) which is contained in the elastomeric composition with the above-noted ranges (e.g., about 5 phr, and thus about 1.25 phr ZnO to about 1.75 phr ZnO per 100 phr CR) performed almost the same in terms of rheometric cure behavior and physical properties as a comparative polychloroprene composition having almost three times as much ZnO (e.g., 5 phr ZnO per 100 phr CR). This trend is expected to follow at the various compositional ranges (e.g., 25%-50% CaO, 2% to 20% MgO, and 25% to 35% ZnO) and the various loadings of the sustainable vulcanizing agent (e.g., 1 phr to 10 phr, more particularly from 3 phr to 8 phr) to reduce the overall amount of ZnO while providing a suitable cure and physical properties. Thus, a surprising aspect of the present disclosure is the significant reduction in ZnO content achieved by using the sustainable vulcanizing agent to provide comparable cure behavior and physical properties as compared against the same elastomeric composition but with ZnO vulcanizing agent instead of the sustainable vulcanizing agent disclosed herein.

### Reinforcing Agent(s)

The elastomeric composition also may include one or more reinforcing agents to enhance specific characteristics, such as the mechanical properties of the elastomeric composition. The additional reinforcing agent(s) may include, for example, one or more carbon black(s), (precipitated) silica(s), calcium carbonate(s) (chalk), clay(s) (kaolin), aluminum silicate(s), calcium silicate(s), magnesium silicate(s) (talc), hydrated alumina(s), or other ceramics or minerals, or mixtures thereof.

In exemplary embodiments, the elastomeric composition contains one or more different types of the reinforcing agent(s). The one or more reinforcing agent(s) may be present in the composition in a total amount from about from about 30 phr to about 100 phr; more particularly from about 30 phr to about 60 phr; or even more particularly from about 30 phr to about 50 phr (including all values between the stated values or ranges and subranges between such values).

In certain embodiments, the elastomeric composition contains one or more types of carbon black(s) as at least one of the additional reinforcing agent(s). Typically, carbon blacks use a naming convention as specified by ASTM D1765 to identify the particular type and size of the carbon black. For N-series carbon blacks, grades range from N110 to N990, in which the first numerical digit designates a size or surface area of the carbon black, and the last two numerical digits designate the structural complexity of the carbon black. A lower first digit (e.g., N100-series) has a smaller particle size, and thus higher surface area, than a higher first digit (e.g., N900-series). Unlike virgin carbon black, recovered carbon black (rCB) does not use the same N-number designation system according to ASTM D1765; however, the rCB still may have at least an equivalent mean particle size as N-series designated virgin carbon black, and thus any designation of an N-type carbon black as used herein encompasses both virgin and other types of equivalent carbon black (e.g., rCB) unless specifically stated otherwise.

In exemplary embodiments, the elastomeric composition contains carbon black(s) in a range between N300-series (e.g., N₂ surface area from about 70 m²/g to about 99 m²/g according to ASTM D3037) and N900-series (e.g., N₂ surface area from about 1 m²/g to about 10 m²/g), in which such carbon blacks(s) are present in the above-noted amounts for the additional reinforcing agent(s)—e.g., in a total amount from about from about 30 phr to about 100 phr (or subranges thereof). In some embodiments, a phr ratio of the smaller size carbon black (e.g., N300-series) to the larger size carbon black (e.g., N900-series) may be from about 20:10 to about 50:50 (including all values and ranges therebetween).

### Plasticizer(s)

The elastomeric composition may contain one or more plasticizers to increase flexibility, reduce hardness, and/or improve the processing characteristics of the composition. The plasticizer(s) may be of any suitable type or combination of types and may be in any suitable amount(s) as may be desired for the application. For example, in conjunction with polychloroprene, the plasticizer(s) may include aromatic or naphthenic process oils; synthetic polymer plasticizers (e.g., polyesters); ester plasticizers (e.g., sebacates, adipates, phthalates, phosphates or oleates) such as dioctyl adipate (DOA); hydrocarbon resins; chlorinated waxes; or the like; or mixtures thereof.

The plasticizer(s) may be present in the elastomeric composition in a total amount from about 1 phr to about 20 phr, more particularly from about 1 phr to about 10 phr, such as about 1, 2, 3, 4, 5, or 10 phr. Polymeric forms of the plasticizer(s) are not calculated in the formulation as part of the base polymer content forming the matrix—i.e., they do not constitute part of the 100 phr base polymer of the composition.

### Acid Receptor(s)

With polychloroprene elastomers, hydrogen chloride may be liberated during processing, and thus a suitable acid receptor may be provided in the elastomeric composition. A suitable acid receptor may include magnesium oxide (MgO), which may be provided in a total amount from about 1 phr to about 10 phr, more particularly from about 3 phr to about 5 phr (including all values between the stated values or ranges and subranges between such values).

### Antidegradant(s)

The elastomeric composition may contain one or more antidegradant(s), which may include antioxidants and/or antiozonants, to prevent oxidation and/or the damaging effects of ozone, which can cause cracking and deterioration of the composition. Examples of the antidegradant(s) used in conjunction with polychloroprene may include, for example, amines (e.g., naphthylamines, diphenyl amine derivatives such as octylated or styrenated diphenylamines, paraphenylenediamines such as N-phenyl-N′-(1,3-dimethylbutyl)-p-phenylenediamine (6PPD), hydrocarbon wax(es) (e.g., paraffinic wax), or the like, or mixtures thereof.

The antidegradant(s) may be present in the elastomeric composition in a total amount from about 1 phr to about 15 phr, more particularly from about 3 phr to about 10 phr (including all values between the stated values or ranges and subranges between such values). In certain embodiments, a mixture of antidegradant(s) may include amine-type from about 1 phr to about 5 phr, and a hydrocarbon wax from about 1 phr to about 5 phr.

### Accelerator(s)

The elastomeric composition also may contain one or more accelerators to accelerate the cure of the composition. Depending on the type of polychloroprene, the plasticizer(s) may include thiourea accelerators (e.g., ethylene thiourea (ETU)), mercapto accelerators (e.g., 2-Mercaptobenzothiazole such as Benzothiazyl Disulfide (MBTS)), or the like, or mixtures thereof.

Generally, G-type polychloroprene elastomer(s) may not utilize an accelerator since the sulfur on the backbone of the material may at least partially satisfy this effect. On the other hand, W-type or T-types may utilize a suitable accelerator, such as one or more of those described above, which may be provided in a total amount from about 1 phr to about 8 phr. As an example, a thiourea accelerator (e.g., ETU) may be provided in a range from about 1 phr to 5 phr, more particularly about 1 to 2 phr; and a mercapto accelerator (e.g., MBTS) may be provided in a range from about 1 phr to about 3 phr, more particularly about 1 phr.

### Processing Aid(s)

The elastomeric composition also may include one or more processing aids to improve processing flow, dispersion of fillers, etc. Examples of processing aid(s) may include stearic acid; waxes (e.g., paraffin or microcrystalline waxes); low molecular weight polyethylene; high-cis polybutadiene; or the like; or mixtures thereof.

The one or more processing aid(s) may be present in the elastomeric composition in a total amount from about 1 phr to about 5 phr, more particularly from about 1 phr to about 2 phr.

### Examples

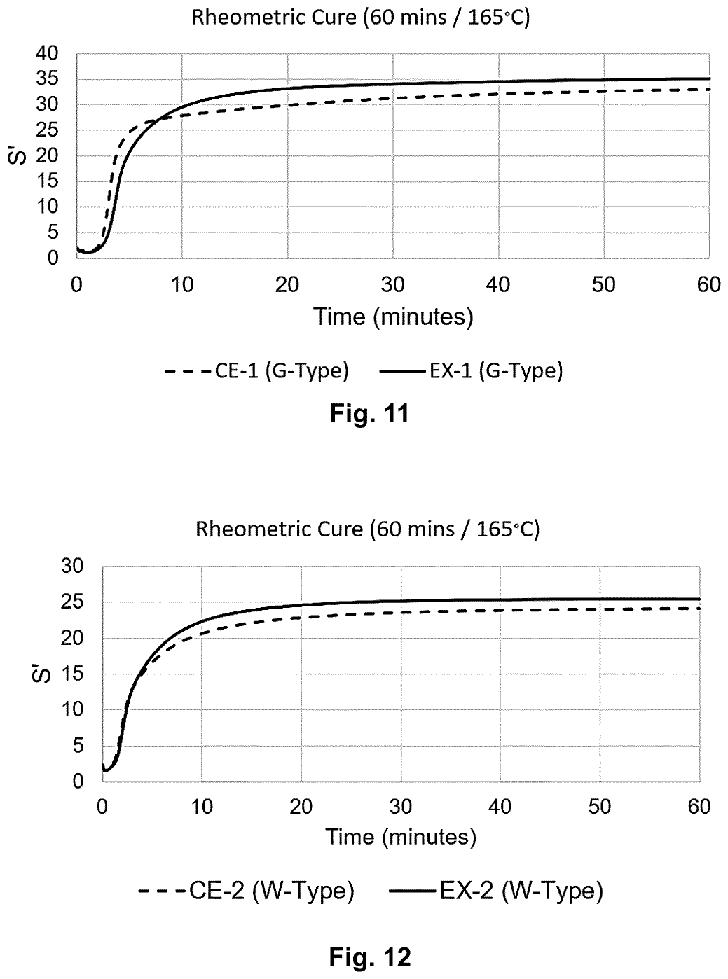

Elastomeric compositions were prepared and tested for the purpose of further illustrating the nature of some of the embodiments and aspects of the present disclosure and are not intended as a limitation on the scope thereof. The test data for these evaluations are shown in Table 1 and in FIGS. 11 and 12. In the test data the evaluations for tensile strength, elongation %, and modulus were conducted according to ASTM D412, and are shown as original (unaged) properties. Hardness testing was conducted according to ASTM D2240. DIN abrasion resistance testing was performed in accordance with ASTM D 5963. Die C Tear testing was conducted according to ASTM D624 standard. Mooney scorch was conducted on a Mooney tester according to the Mooney Scorch ASTM D1646 standard. Mooney viscosity was conducted according to ASTM D-1646]. Compression set was conducted according to ASTM D-395, Method B, Type 1, Option 1.

Referring to Table 1, various elastomeric formulations for different test samples are shown. This includes two comparative examples (CE-1, CE-2) that use zinc oxide as the vulcanizing agent, and two examples according to the present disclosure (EX-1, EX-2) that use the sustainable vulcanizing agent as the vulcanizing agent. As shown, CE-1 and EX-1 are used to compare results using 100 phr of G-Type polychloroprene elastomer, and CE-2 and EX-2 are used to compare results using 100 phr of W-type polychloroprene elastomer. The sustainable vulcanizing agent was Oxi-Rubber Max P having a compositional specification of 25% to 35% CaO, 5% to 15% MgO, and 25% to 35% ZnO, as described above. Thus, such a sustainable vulcanizing agent used at 5 phr in accordance with the examples has, on average, 1.5 phr CaO, 0.5 phr MgO and 1.5 phr ZnO. The average ZnO content of the sustainable vulcanizing agent is shown in Table 1 in parenthesis for ease of comparison. The carbon black(s) used in the examples were one or more types in the N300-series to N900-series range. The plasicizer(s), processing aid(s), antidegradant(s), accelerator(s), etc. were one or more types in accordance with the description above.

TABLE 1

| Ingredient | CE-1 | EX-1 | CE-2 | EX-2 |
|---|---|---|---|---|
| Polychloroprene (G-Type) | 100 | 100 | | |
| Polychloroprene (W-Type) | | | 100 | 100 |
| Carbon black(s) (N300-N900) | 35 | 35 | 35 | 35 |
| Plasticizer(s) | 10 | 10 | 10 | 10 |
| Paraffinic wax | 2.9 | 2.9 | 2.9 | 2.9 |
| Magnesium Oxide | 4 | 4 | 4 | 4 |
| Acid Receptor | | | | |
| Zinc Oxide Vulcanizing | 5 | | 5 | |
| Agent | | | | |
| Sustainable Vulcanizing | | 5 (1.5 | | 5 (1.5 |
| Agent | | ZnO) | | ZnO) |
| Accelerator(s) | | | 2.13 | 2.13 |
| Antidegradant(s) | 2.65 | 2.65 | 2.65 | 2.65 |
| Stearic acid Processing aid | 0.5 | 0.5 | 0.5 | 0.5 |
| Total phr | 160.05 | 160.05 | 162.18 | 162.18 |
| Mooney Viscosity (@100 C.) | | | | |
| ML(1 + 4) | 29.63 | 28.61 | 33.97 | 34.03 |
| Mooney Scorch (30/121 C.) | | | | |
| ML | 8.7 | 6.69 | 13.45 | 13.33 |
| t5 | | | 21.87 | 25.63 |
| Rheometer (60 mins/165 C.) | | | | |
| Min | 1.31 | 1.12 | 1.51 | 1.5 |
| Max | 33.03 | 35.05 | 24.07 | 25.37 |
| Tris1 | 2.05 | 2.25 | 1.08 | 1.24 |
| T25 | 2.89 | 3.53 | 1.93 | 2.12 |
| S25 | 9.24 | 9.6 | 7.15 | 7.47 |
| T90 | 19.61 | 13.86 | 13.81 | 11.79 |
| S90 | 29.86 | 31.65 | 21.82 | 22.99 |
| Rate | 15.66 | 11.55 | 7.57 | 7.96 |
| Amount | 31.71 | 33.93 | 22.56 | 23.87 |
| Original Physical Properties | | | | |
| Tensile, MPa | 16.1 | 15.1 | 17.1 | 16.2 |
| Elongation, % | 425 | 379 | 386 | 374 |
| Mod 100, MPa | 2.4 | 2.5 | 2.1 | 2.0 |
| Mod 200, MPa | 5.5 | 5.7 | 5.8 | 5.4 |
| Mod 300, MPa | 10.4 | 10.9 | 11.8 | 11.3 |
| Shore A Hardness | 63 | 63 | 58 | 58 |
| Tear Test (Die C), N/mm | 38 | 36 | 33 | 31 |
| DIN Abrasion, mm³ | 82 | 84 | 69 | 65 |
| Compression Set | 31 | 26 | 12 | 11 |
| (24/100 C.), % | | | | |

In view of these results, the present inventors were surprised to discover that the sustainable vulcanizing agent with such a reduced amount of ZnO (about 3 times less total ZnO) was capable of achieving about the same properties as the comparative compositions when the sustainable vulcanizing agent was used as a one-to-one phr replacement for the ZnO vulcanizing agent alone. For example, the properties of the exemplary composition exhibited about a plus-or-minus 10% change (or less) in the properties of tensile, modulus, hardness, tear strength, and DIN abrasion. The W-type polychloroprene elastomer exhibited even closer properties than the G-type. This enables such exemplary compositions formed from polychloroprene elastomer(s) and sustainable vulcanizing agent to be direct replacements for conventional polychloroprene containing elastomeric articles.

Even more surprising to the inventors was the discovery that the exemplary composition with the sustainable vulcanizing agent exhibited essentially the same cure behavior as the comparative compositions that used only ZnO. These results are shown in FIG. 11 (G-Type) and FIG. 12 (W-Type), wherein even the onset cure behavior of the compositions closely follow each other. This enables such exemplary compositions to be formed in the same economical manner as conventional polychloroprene containing articles.

### Article Embodiment(s)

Certain embodiments of the disclosure will hereafter be described with reference to the accompanying drawings, in which like reference numerals denote like elements. It should be understood, however, that the accompanying figures illustrate the various implementations described herein and are not meant to limit the scope of various technologies described herein. In addition, it is understood that various aspects and features of these embodiments may be substituted for one another or used in conjunction with one another where applicable. Furthermore, it is understood that the description of material(s) forming the various parts of one embodiment article may be the same material(s) for the same or similar part in another embodiment article, except as otherwise noted below.

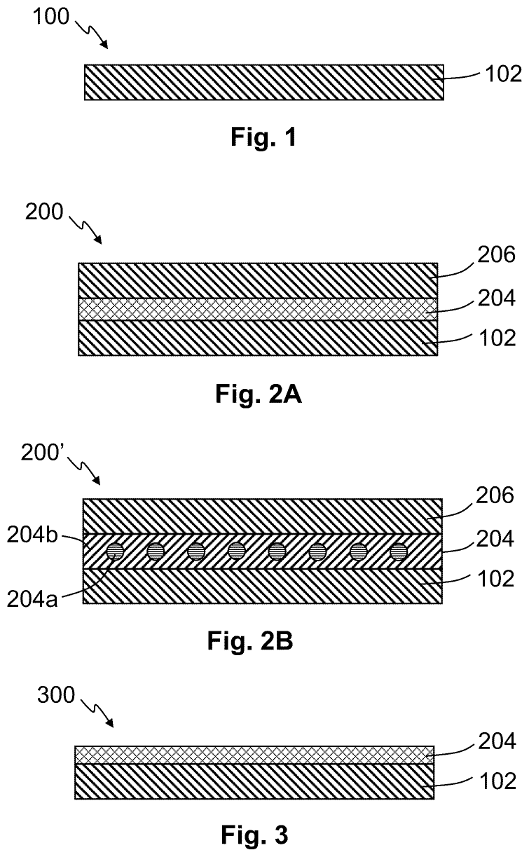

Referring to FIG. 1, a cross-sectional view of an article 100 (or portion thereof) having an elastomeric layer 102 formed from the exemplary elastomeric composition described above. This article 100 may be at least part of any suitable elastomeric article, such as a membrane, seal, gasket, damper, or the like, or a single-walled elastomeric article such as a mono-layered hose, etc.

FIG. 2A shows a cross-sectional view of another article 200 (or portion thereof), which includes a reinforcement layer 204 embedded between two elastomeric layers 102 and 206. At least the elastomeric layer 102 is formed from the exemplary elastomeric composition described above. The elastomeric layers 102, 206 may be the same composition or may be different, and the layers 102, 206 may have different constructions such as different thicknesses or material properties.

The reinforcement layer 204 provides additional strength to the article 200 by applying strands of reinforcement to the article. The reinforcement strands may have any suitable configuration or combination of configurations, and the strands may be made of any suitable material or combination of materials for reinforcing the article 200. The reinforcement layer 204 may include one or more layers of such strands, which these strand layers may be directly radially adjacent to each other and/or may be separated by intervening layer(s) of material (e.g., elastomeric layer(s) between strand layers).

Generally, reinforcement strands may include elongated fibers, filaments, threads, wires, or the like, which may be in monofilament or multi-filament form. The individual strands may be grouped together to form bundles, tows, yarns, cables, cords, or the like. Generally, a tow is a bundle of untwisted individual strands that are typically held together by a binding agent. A yarn is a grouping of individual strands that are twisted or bundled (cabled) together, typically formed from synthetic materials. A cable is a grouping of individual strands that are twisted or bundled (cabled) together, typically formed from inorganic material such as metal. A cord is a collection of yarns or cables that are twisted, braided, or bundled together. Depending on the construction of the reinforcement, the individual strands or grouping of strands (yarns, cables, etc.) may be arranged in a spiral, braided, knitted, woven, wrapped or like reinforcement construction, as may be desired for the particular application. In some embodiments, the reinforcement layer may include one or more of layers of reinforcement strands, and each layer may have the same or different arrangement or orientation of the strands or collection of strands.

The material of the reinforcement strands may include, but is not limited to, synthetic, inorganic, or natural material, or mixtures thereof. For example, synthetic materials, such as synthetic polymers, may include for example acrylonitrile, polyacrylonitrile, polyolefin such as polyethylene (PE) (e.g., LD-PE, LLD-PE, UHMW-PE) or polypropylene (PP), polyester such as polyethylene terephthalate (PET) or polyethylene 2,6-naphthalate (PEN) or polybutylene terephthalate (PBT), polyamide (PA) (e.g., PA 6 or PA 6,6), polyimide, polyurethane, polyoxadiazole, rayon, aramids (e.g., p-aramid, m-aramid or copoly-para-aramid), polyetherimide, polyetheretherketone, polyphenylene, polyphenylene oxide, polyphenylene sulfide, polyphenylene ether, polybenzoxazoles, polysulfone, polyvinyl acetal, polyvinyl alcohol, or the like. Other synthetic materials for strands may include, for example, carbon fiber or glass fiber. Inorganic materials for the strands may include ceramic, carbon, metal, glass, minerals, or the like. Natural materials for the strands may include cotton, jute, flax, hemp, wool, silk, or the like. Hybrid designs in the form of mixed collection of strand materials and/or mixed constructions can also be used to form a cable, yarn, cord, etc. To improve bonding of adjacent elastomeric material to the strands, the strands or collection of strands may be coated with a material, such as resorcinol formaldehyde resin or resorcinol formaldehyde latex (RFL), for example.

In the illustrated embodiment, the reinforcement layer 204 of article 200 is shown to have the reinforcement strands arranged in one or more plies of textile. The one or more textile plies of the reinforcement layer 404 may be formed from a suitable fabric, such as one or more of bi-directional, non-woven, woven, knitted, or braided fabric, or the like. The fabric may include warp and weft threads laid at any desired angle. If desired, the fabric may be cut on a bias so that the strands form an angle with the longitudinal direction of the. The angle may be of any suitable angle, for example, but not limited to 0 or 90 degrees, or any point along the continuum there between.

In embodiments where more than one ply of textile is employed, an intervening elastomeric skim layer (or coating) may be utilized between the textile plies, which this skim layer may be applied via a calendaring process, for example. The surface between of the reinforcement layer 204 adjacent to the elastomeric layer 102 also may include an elastomeric skim layer or coating, which may assist in bonding to the elastomeric layer 102. Likewise, the surface of the reinforcement layer 204 adjacent to elastomeric layer 206 may include an elastomeric skim layer or coating, which may assist in bonding to the elastomeric layer 206. The skim layers or coatings on the opposite sides of the reinforcement layer 204 may be the same or may be different, for example if the compositions of the layers 102 and 306 are correspondingly the same or different.

FIG. 2B illustrates an article 200′ that is substantially the same as the article 200 except the reinforcement layer 204 of article 200′ includes reinforcing cords 204a that are embedded in an elastomeric body 204b to form a carcass of the article 200′. The reinforcing cords 204a may be made of any suitable material, may have any suitable thickness, and may be provided in any suitable number or arrangement to provide a major load carrying or reinforcement capability of the article 200′. For example, the reinforcement cords may extend parallel to each other and generally in the longitudinal direction of the article 200′. The reinforcement layer 204 may include one or more plies of such reinforcing cords 204a.

As discussed above, reinforcing cords 204a may be formed from a collection of reinforcement strands (e.g., wires, fibers, etc.) that are twisted or bundled together to form a yarn or cable, in which a grouping of these yarns or cables are then twisted, braided or bundled together to form the final cord structure. The yarns, cables, or cords may be characterized by their particular denier, twist, turns per inch, ends per decimeter, or the like. Each individual strand, yarn, cable, and/or overall cord may be twisted clockwise (Z-twist) or counterclockwise (S-twist) as desired for the application. The strands, yarns, cables, and/or cords may be twisted in the same direction relative to each other, or may be twisted in opposite directions relative to each other. For example, the yarns or cables may be twisted in the same direction, while the cord may have an opposing twist direction to form a more tightly bound and stronger cord.

The material(s) forming the reinforcing cords 204a may include synthetic, inorganic or natural material, such as any of those described above in connection with reinforcement textiles for article 200, or other articles described herein where applicable. This may include synthetic polymers, natural materials, inorganic materials such as ceramic, carbon, metal, or the like. Hybrid designs, for example in the form of a mixed cord can also be used. The cords 204a (or strands thereof) may be coated with a suitable material to facilitate bonding to the elastomeric body 204b forming the carcass.

Examples of such elastomeric article(s) 200, 200′ with embedded reinforcement may include power transmission belts, conveyor belts, bellows such as for air springs, reinforced hoses, reinforced seals, gaskets, dampers, or the like.

FIG. 3 shows a cross-sectional view of another article 300 (or portion thereof) that is similar to article 200, except that article 300 includes reinforcement layer 204 on at least one side of the article. The reinforcement layer 204 may be directly or indirectly coupled to elastomeric layer 102. The reinforcement layer 204 may form an outermost layer of the article, or may form an innermost layer of the article, as may be desired for the particular application. The reinforcement layer 204 may be applied to both sides of the article 300. The reinforcement layer 204 may cover only a portion of the article 300, may cover an entirety of an outer and/or inner surface of the article 300, or may encapsulate the entirety of the article 300.

The reinforcement layer 204 may be the same as or similar to reinforcement layer 204 described above in connection with article 200, for example having a textile reinforcement structure, and thus the same descriptions apply where applicable. Also similarly to the reinforcement layer 204 of article 200, the reinforcement layer 204 in article 300 may include elastomeric skim layer(s) or coatings between layers of textile, or may include elastomeric skim layer(s) or coatings on either side of the reinforcement layer 204. For example, the inner surface of reinforcement layer 204 may include a skim layer or coating to facilitate bonding to elastomeric layer 102. The outer surface of the reinforcement layer 204 also may include an elastomeric skim layer or coating, which may be the same or different from the inner skim layer or coating, and which may provide low friction, abrasion resistance, or other suitable function.

Examples of such reinforced elastomeric article 300 may include reinforced seals, gaskets, dampers, or the like. It is of course understood that in some embodiments, the textile reinforcement layer 204 of article 300 could be applied to an outer or inner surface of the embedded reinforcement article 200, 200′.

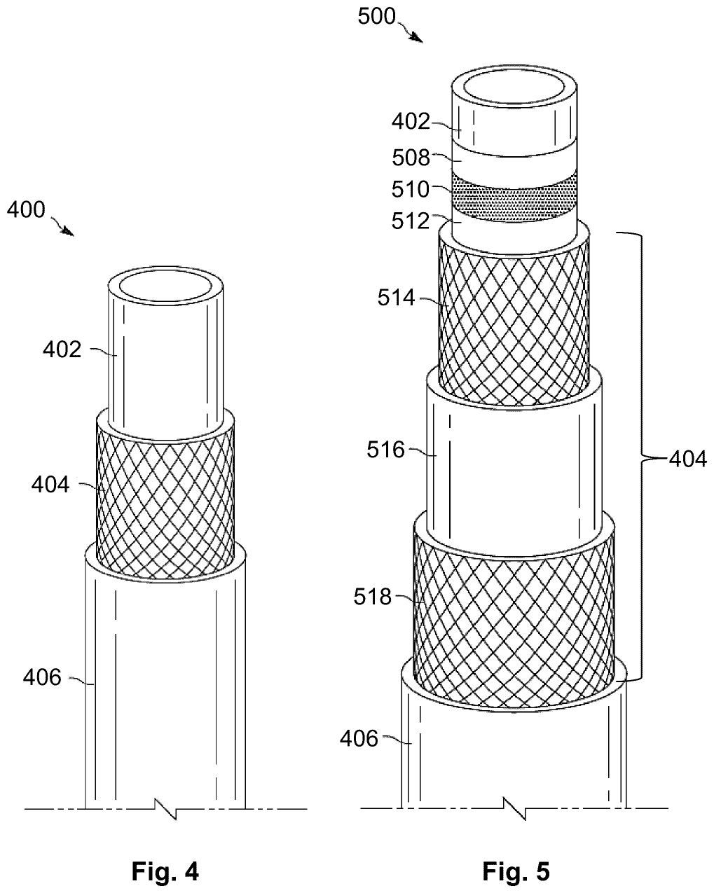

Turning to FIG. 4, a more detailed view of exemplary multilayer hose 400 is shown in a cut-away perspective view. The hose 400 may have structure(s) similar to that described above in connection with article 200, 200′ and thus the same descriptions may apply where applicable. As shown, the hose 400 includes an elastomeric layer 402 forming an inner tube that forms an internal fluid passage, or lumen, through which fluid is conveyed. A reinforcement layer 404 is disposed outwardly of the inner tube 402. A cover layer 410 is disposed outwardly from the reinforcement layer 408 and is the outermost layer of the illustrated hose 400. The exemplary elastomeric composition formed from polychloroprene elastomer(s) and sustainable vulcanizing agent as described herein may form any elastomeric layer of the hose 100.

Generally, the hose 400 may have an inside diameter which is within the range of about 0.5 inch (12.7 mm) to about 6 inches (about 150 mm) and an outside diameter of about 1 inch (25.4 mm) to about 8 inches (about 203 mm). The overall wall thickness of the hose including all layers may be within a range from about 0.10 inch (2.5 mm) to about 0.5 inch (12.7 mm) or more.

The inner tube 402 of the hose 400 may be formed from an elastomeric composition which provides flexibility and elasticity. The elastomeric composition forming the inner tube 402 of the hose also should have suitable chemical resistance to the substance being conveyed by the hose. The inner tube 402 may have any suitable wall thickness to provide the properties desired for the application. In certain embodiments, hose 400 may have an inside diameter which is within the range of about 0.5 inch (12.7 mm) to about. The wall thickness of the inner tube 402 may be in a range from about 0.02 inch (0.5 mm) to about 0.16 inch (4 mm), more particularly from about 1 mm to about 3 mm.

The reinforcement layer 404 provides additional strength to the hose, typically by applying strands of reinforcement around the inner tube 402 or other inner layer. The strands may have any suitable configuration or combination of configurations, and the strands may be made of any suitable material or combination of materials for reinforcing the hose. Examples of suitable materials and configurations of the strands may be the same as or similar to those described above in connection with reinforcement layer 204 of article 200, 200′, 300, and thus the same descriptions apply where applicable.

For example, the reinforcement strands may include metal wire (such as steel wire, stainless-steel wire, plated-steel wire, plain steel wire, or the like); or synthetic, inorganic or natural materials as described above. The individual strands or grouping of strands may be arranged in a spiral, braided, knitted, fabric, or wrapped reinforcement construction. In some embodiments, the hose may include one or more of these layers of reinforcement, and each layer may have a different orientation of strand arrangement. For example, where two or more layers of spiral reinforcement may be used, a first layer may be spiral wound in a first winding direction, and a second layer spiral wound in a second winding direction opposite the first winding direction. A braided configuration may include groupings of strands arranged in a 1-over, 1-under braid pattern, a 3-over, 3-under braid pattern, or a 4-over, 4-under braid pattern, or the like. When multiple plies of reinforcement strands are utilized in the reinforcement layer 404 (e.g., spiral wound, braided, or the like), they may be directly radially adjacent to each other or may be separated by intermediate layer(s) of elastomeric material.

The cover layer 406 is located outwardly of the reinforcement layer 404 and serves to protect the inner layers from the environment of the hose when deployed for use in the field. The cover layer 406 may have any suitable configuration and be made of any suitable material. Several factors may be used to determine the construction and/or materials selection for the cover layer, including but not limited to abrasion resistance, chemical resistance, economy, formability, aesthetics, or the like. The cover layer 406 may have any suitable wall thickness, such as from about 0.060 inches (1.5 mm) to about 0.120 inches (3.0 mm), from about 0.070 inches (1.5 mm) to about 0.110 inches (2.8 mm) in thickness, or from about 0.080 inches (1.8 mm) to about 0.100 inches (2.5 mm) in thickness.

FIG. 5 shows another embodiment of an exemplary multilayer hose 500 including inner tube 402, reinforcement layer 404, and cover layer 406, each of which may be the same or different as the hose 400 described above. As shown, the hose 500 may further include additional intermediate layers 508, 510, and 512 between the inner tube 402 and reinforcement layer 404.

In exemplary embodiments, the intermediate layer 510 may be formed as a barrier layer 510 which is adapted to restrict permeation of the substance being conveyed. The barrier layer 510 is not particularly limited, but may be produced from a thermoplastic material, such as polyamide or a thermoplastic fluoropolymer, such as Polyvinylidene fluoride (PVDF), Tetrafluoroethylene-Hexafluoropropylene-Vinylidene Fluoride (THV), or the like. To provide suitable permeation restriction while enabling sufficient flexibility of the hose, the barrier layer 510 may be relatively thin, such as in a range from about 0.002 inch (0.05 mm) to about 0.01 inch (0.254 mm) thick.

The intermediate layers 508, 512 on opposite sides of the barrier layer 510 may be utilized as bonding layers or tie layers to improve adhesion of the barrier layer 510 within the hose to the other layers, such as to the inner tube layer 402 and/or to the reinforcement layer 404. As such, the intermediate layer 508 may be in direct contact with the inner tube 402 and the barrier layer 510, and the intermediate layer 512 may be in direct contact with the reinforcement layer 404 and the barrier layer 510. These intermediate layers 508, 512 may be made of a suitable elastomeric material for compatible bonding, or they may be adhesive layers for such bonding. It is of course understood that the various layers may be formulated for direct bonding without intervening adhesives or other layers, and as such the barrier layer 510 may be direct bonded to the inner tube 402, the reinforcement layer 404, or other suitable layers, as may be desired for the particular application. As such, one or more of the intermediate layers 508, 512 may be absent in the hose 500. Of course, additional layers also may be provided.

Although shown as a barrier layer 510 disposed outwardly of the inner tube 402, it is understood that the barrier layer 510 may alternatively or additionally be formed as a veneer layer inwardly of the inner tube 402 to define the lumen of the hose 500. Such a veneer layer may be made of similar materials and have similar thicknesses as barrier layer 510 described above, and may be directly bonded to its adjacently outward layer or may be bonded with suitable adhesives or the like.

Also as shown in the hose 500, the reinforcement layer 404 may include at least two layers of reinforcement 514, 518 which are separated by an intermediate layer 516. The layers of reinforcement 514, 518 may be as described above in connection with hose 400. It is understood, of course, that additional layers of reinforcement and intermediate layers therebetween may be provided as may be desired for the particular application. Any of these reinforcement layers or intermediate layers may be of the same or different materials, or may be of the same or different constructions. In some embodiments, one or more of the layers of reinforcement may be directly adjacent to each other without an intervening layer (e.g., layer 516).

The intermediate layer 516 may be formed from any suitable elastomeric composition and may serve as a tie layer or a friction layer between the reinforcement layers 514, 518. Generally, the intermediate layer 516 serves as a tie layer when the reinforcement strands in the layer(s) 514, 518 are braided and/or do not have sufficient openings between the strands to permit the elastomeric material of adjacent layers to strike therethrough and bond together. As such, the intermediate layer 516 serving as tie layer is directly adjacent and bonded to the reinforcement strands of the reinforcement layers 514, 518. As noted above, such reinforcement strands may have suitable coatings thereon to promote such bonding. On the other hand, the intermediate layer 516 generally serves as a friction layer when the reinforcement strands in the layer(s) 514, 518 are spiral wound and/or have sufficient openings between the strands to permit the elastomeric material of adjacent layers to strike therethrough and bond together. For example, the material of the intermediate (friction) layer 516 may strike through the reinforcement layer 518 to bond to the material of the outer cover layer 406. In such a case, the intermediate layer 516 may not provide bonding to the strands of the reinforcement layers 514, 518. In either case, the intermediate layer 516 may have any suitable wall thickness for the application, and in some embodiments may be in a range from about 0.010 inches (0.25 mm) to about 0.120 inches (3 mm), for example.

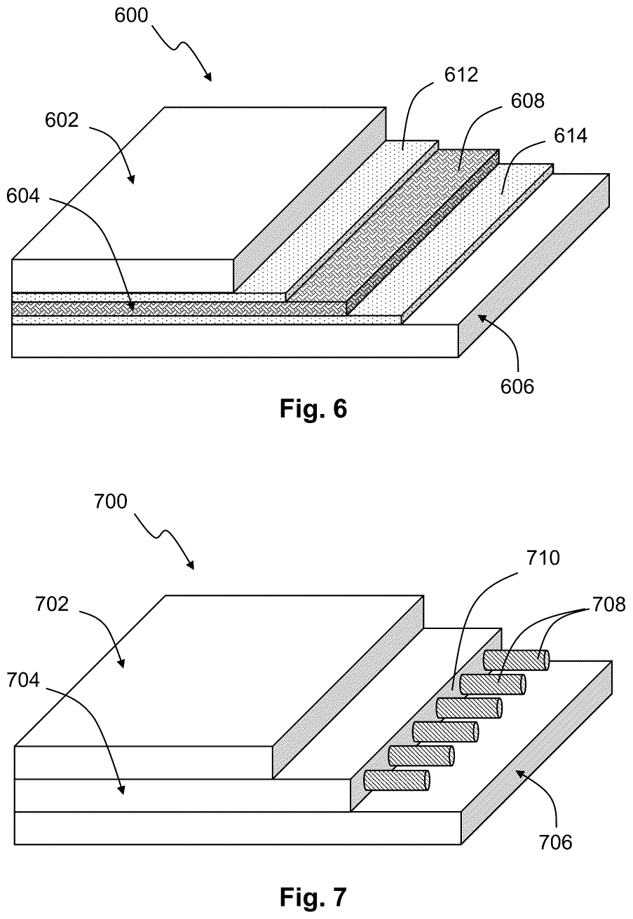

Referring to FIG. 6, a portion of an exemplary conveyor belt 600 is shown, which may have structure(s) similar to that described above in connection with article 200 and thus the same descriptions may apply where applicable. The conveyor belt 600 includes a top or carry cover layer 602, a bottom or pulley cover layer 606, and a reinforcement layer 604 between the top cover layer 602 and the bottom cover layer 604. The top cover layer 602 is configured to carry the material being conveyed, and may include a coating layer such as a fabric or abrasion resistant coating that restricts wear. The bottom cover layer 606 is configured to pass over rollers or pulleys in the conveyor system which support the conveyor belt 600, and thus at least the bottom cover layer 606 may locally deform to generally match the shape of the roller as it passes thereover. The exemplary elastomeric composition formed from polychloroprene elastomer(s) and sustainable vulcanizing agent as described herein may form any elastomeric layer of the belt 600.

The reinforcement layer 604 provides a major load carrying capability of the belt 600. The reinforcement layer 604 may be formed in the manner described above for reinforcement layer 204 for article 200. In the illustrated embodiment, for example, one or more layers of textile 608 are provided in reinforcement layer 604. The textile 608 may include at least one fabric which may be formed from those textile materials described above, such as aramid, polyester, nylon, or any other suitable material or any suitable combination thereof. The textile 608 may be attached to the top and bottom cover layers 602, 606 with respective skim layers 612, 614 which coat opposite surfaces of the textile 608 and together form the reinforcement layer 604 or carcass of the belt. Multiple textile layers 608 with skim layer(s) 612 and/or 614 between the textile layers may be utilized as desired to form the reinforcement layer 604.

FIG. 7 shows a portion of another exemplary conveyor belt 700, which is constructed substantially similar to the belt 600, except that reinforcement layer 704 of belt 700 includes reinforcing cords 708 that are oriented parallel to each other and are embedded in an elastomeric body 710 to form a carcass of the belt 700. The belt 700 may have structure(s) similar to that described above in connection with article 200′ and thus the same descriptions may apply where applicable. For example, the reinforcing cords 708 may be constructed as described above for the reinforcement layer 204 of article 200′. Thus, for example, the reinforcing cords 708 may be formed from a plurality of wound steel wires which provide a major load carrying capability for the belt 700.

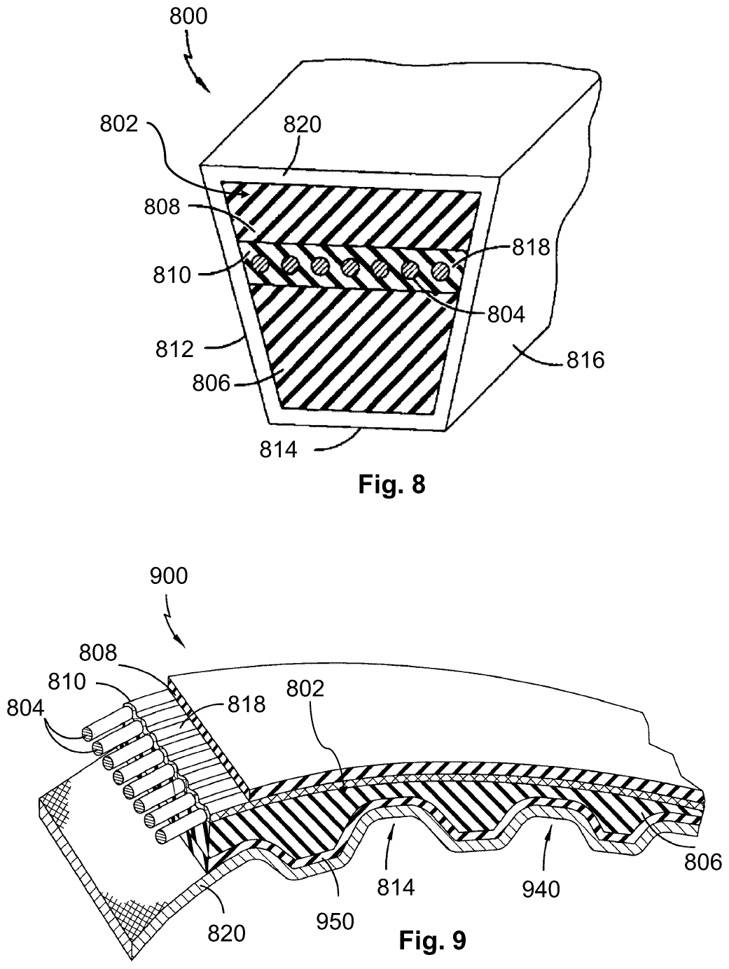

Turning to FIG. 8, a cross-sectional view of a portion of a power transmission belt 800 is shown. In the illustrated embodiment, the power transmission belt 800 is formed as a V-belt. The power transmission belt 800 may have structure(s) similar to that described above in connection with article 200′ and thus the same descriptions may apply where applicable. As shown, the power transmission belt 800 includes an elastomeric body 802 including an inner engagement section 806, an outer section 808, and a load carrying 810 section between the inner section 806 and the outer section 808. The belt 800 is configured to engage with a pulley/sheave and includes at least one drive surface. In the illustrated V-belt, there are three drive surfaces 812, 814, 816 that are configured to engage within the groove of the pulley/sheave. The exemplary elastomeric composition formed from polychloroprene elastomer(s) and sustainable vulcanizing agent as described herein may form any elastomeric layer of the belt 800.

In the illustrated embodiment, the load carrying section 810 includes reinforcement cords 804 (also referred to as tensile cords) and provides a majority of the tensile strength to the belt. The load carrying section 810 may be formed in the same or similar manner as described above for reinforcement layer 204 of article 200′, and thus the reinforcement cords 804 may be constructed the same as or similar to the reinforcement cords 204. As shown, the reinforcement cords 804 may be embedded in an elastomeric cushion or matrix 818 portion of the elastomeric body 802. The reinforcement cords 804 may extend generally in the longitudinal direction of the belt. The load carrying section 810 may include one or more plies of such tensile cords 804. These reinforcement cords 804 may be made of any suitable material or combination of materials and may have any suitable form as may be desired for the particular application. For example, the cords may be formed from synthetic yarn materials(s) having a particular denier and twist, including particular ply twist, yarn twist, and cord twist.

The outer section 808 (also referred to as the cover, backing or spine section) overlies at least the load carrying section 810 and provides protection to the load carrying section 810 having the reinforcement cords 804. The inner engagement section 806 underlies the load carrying section 810 and experiences compressive load from the pulleys/sheaves or other component of the power transmission system. As such, the inner engagement section 806 is also referred to as a compression section, or cushion section, and distributes load to the reinforcement cords 804. As shown, the inner (cushion) section 806 may constitute a majority of the volume of the belt. The elastomeric body 802 may have a generally trapezoidal shape and the elastomeric nature of the inner engagement section 806 can provide for firm lateral pressure against the sheave/pulley sidewall.

In some embodiments, the power transmission belt 800 may be provided with one or more fabric layers 820 on one or more of its sides. In the illustrated embodiment, the belt 800 is wrapped with the fabric layer 820 on all sides. In other embodiments, the fabric reinforcement layer 820 may be at least partially embedded in the cross-linked elastomeric body 802, which may give rise to both the elastomeric body and fabric reinforcement forming an outer surface of the belt. Generally, the fabric reinforcement layer 820 may be provided at least on the drive surface(s) 812, 814, 816 to enhance the mechanical stability of these surfaces and may provide a wear resistant surface to engage pulleys. In some embodiments, the belt 800 may be provided without a fabric layer 820 on one or more sides and is referred to as a raw edge belt. Generally, the fabric reinforcement layer 820 is formed from reinforcement strands of any suitable material or arrangement, such as those described above in connection with reinforcement layer 204 of article 300. For example, the fabric layer 820 may be formed from synthetic yarns including a bi-directional, non-woven, woven, knitted, or braided fabric.

The drive surfaces 812, 814, 816 of the belt 800 may be smooth, as shown, or the inner engagement section 806 may include longitudinal or transverse grooves or ribs that engage corresponding pulley/sheave grooves in the power transmission system. The outer engagement section 810 also may have grooves or teeth, forming a dual sided belting. The grooves or teeth may be provided as single V-grooved, multi-V-grooved or synchronous in which an inner toothed surface that engages with tooth spaces on the periphery of a mating sprocket.

FIG. 9 illustrates another exemplary embodiment of an endless power transmission belt 900, which is in the form of a timing belt. The structure(s) of the belt 900 may be substantially the same as or similar to those of the belt 800, and thus the same descriptions apply where applicable. As shown, the belt 900 includes elastomeric body 820 having inner (cushion) section 806, load carrying section 810, and outer section 808. The load carrying section 810 includes reinforcement cords 804 embedded in matrix 818. The inner (cushion) section 806 has transverse grooves 940. The belt 900 is a raw edge belt and has fabric layer 820 adhered below the elastomeric inner cushion section 806 to form drive surface 814. The belt 900 may have an insulation layer 950 located between the inner (cushion) section 806 and the fabric layer 920 to prevent or decrease rubber from the inner (cushion) section 806 from permeating through the fabric 820 to the drive surface 814.

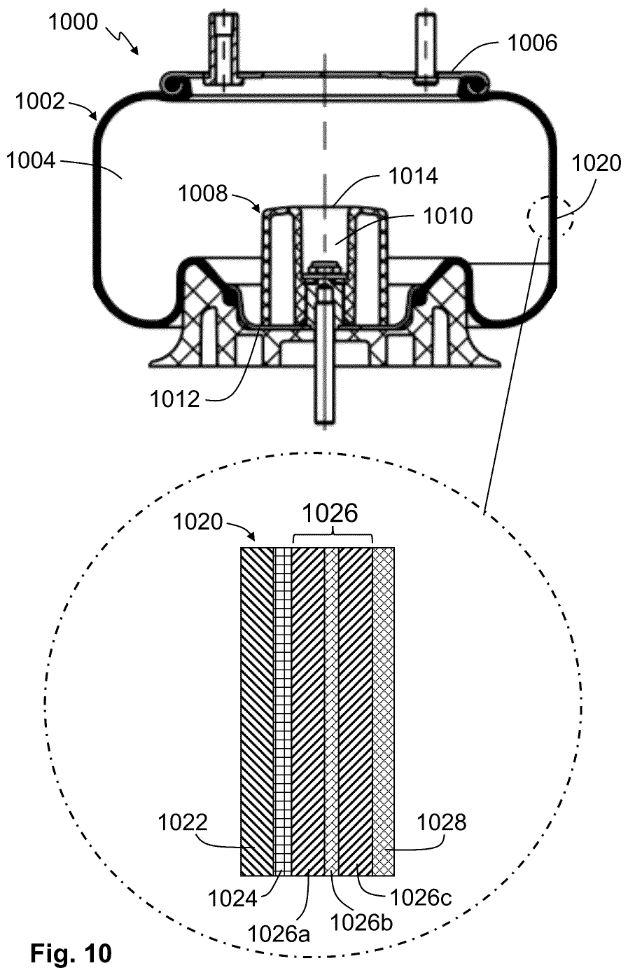

Referring to FIG. 10, an example of an air spring 1000 is shown. The air spring 1000 includes a bellows 1002, a bellows chamber 1004, a bellows top plate 1006, and a piston 1008 having a piston chamber 1010. The piston 1008 includes a lower plate 1012 and an upper plate 1014. The upper plate 1014 includes at least one opening, which allows fluid communication between the piston chamber 1010 and the bellows chamber 1004. This fluid communication between piston chamber 1010 and bellows chamber 1004 through opening(s) in top plate 1014 provides viscous damping to the air spring during operation of the vehicle.

As shown in the enlarged view of FIG. 10, the flexible bellows 1002 of the air spring includes a multilayer main body 1020 including at least one elastomeric layer formed from the exemplary elastomeric composition formed from polychloroprene elastomer(s) and sustainable vulcanizing agent as described herein. The air spring bellows 1002 may have structure(s) similar to that described above in connection with article 200 and thus the same descriptions may apply where applicable. For example, in the illustrated embodiment, the multilayer main body 1020 of the bellows includes at least one elastomeric inner layer 1022, at least one reinforcement layer 1024, and at least one elastomeric outer layer 1026.

The elastomeric inner layer 1022 is often referred to as an “inner cap” and is typically formed from an elastomeric composition having good elastic properties. The reinforcement layer 1024 provides reinforcement strength to the bellows and is often referred to as the skeleton. The reinforcement layer 1024 may include any suitable construction of reinforcement strands formed from any suitable material(s), such as in the manner described above for reinforcement layer 204 of article 200. For example, the reinforcement layer 1024 may include a textile, such as a cord weave formed from one or more laminas having good adhesion to the inner layer 1022. The textile (e.g., cord weave) may include elastomeric skim layers on one or both sides to facilitate such adhesion.

The outer layer 1026 is often referred to as an “outer cap” having one or more lamina formed from an elastomeric composition. In the illustrated embodiment, the outer layer 1026 includes an inner portion 1026a (or inner lamina) and an outer portion 1026c (or outer lamina). The inner and outer lamina 1026a may be formed from suitable elastomeric composition and may have a reinforcement 1026b therebetween. The elastomeric compositions of the inner and outer lamina 1026a, 1026b may be the same or may be different, and at least one of these elastomeric compositions may have fire-resistant properties. The outer lamina 1026c may completely or partially cover the main body 1020, in which partial coverage may be positioned at locations exposed to fire risk. The reinforcement layer 1026c may include any suitable reinforcement strands (as described above) such as a suitable textile, for example a weave or loop-formed knit or loop-drawn knit which is embedded between the inner and outer lamina 1026a, 1026b. The reinforcement strands may have a suitable coating to facilitate adhesion to the elastomeric compositions of the lamina 1026a, 1026b.

In some embodiments, the main body 1020 of the bellows 1002 may include an intermediate thermoplastic layer (not shown), for example a polyolefin, such as polyethylene (PE) (e.g., LD-PE, LLD-PE, UHMW-PE) or polypropylene (PP), polystyrene (PS), polyamide (PA) (e.g., PA 6 or PA 6,6), polyesters (e.g., PET, PEN, PBT), or the like. The intermediate thermoplastic layer may be located on the side of reinforcement layer 1026b facing outer lamina 1026c, and may be in the form of a film. In some embodiments, the main body 1020 may also include an outer reinforcement layer 1028 atop the outer layer 1026. This reinforcement may be of any suitable construction or material(s), for example a fabric in the form of a weave having warp and weft, such as a bi-stretch weave, which may be the same as reinforcement layer 1024. The outer fabric reinforcement layer 1028 may provide additional strength and support as well as reduce the coefficient of friction of the surface of the main body 1020.

It is understood that the article(s) 100, 200, 300, 400, 500, 600, 700, 800, 900, 1000 are not limited to the layers shown, but also could include additional layers on either side or as intermediate layers, or may eliminate some layer(s), as may be desired for the particular application. As noted above, the exemplary elastomeric composition formed from polychloroprene elastomer(s) and sustainable vulcanizing agent may form any of one or more layers of such articles.

In those embodiments in which a layer of the article is not formed from the exemplary elastomeric composition, such layer may be formed from a different elastomeric composition, which may include, but is not limited to, natural rubber (NR), epoxidized natural rubber (ENR), polybutadiene rubber (BR), acrylonitrile butadiene rubber (NBR), carboxylated nitrile rubber (XNBR), (partially) hydrogenated nitrile rubber (HNBR), styrene butadiene rubber (SBR), carboxylated styrene-butadiene rubber (XSBR), styrene/ethylene-butylene/styrene-based (SEBS), ethylene propylene monomer (EPM), ethylene propylene diene monomer (EPDM), chloroprene rubber (CR), isoprene rubber (IR), butyl rubber (IIR), bromobutyl rubber (BIIR), chlorobutyl rubber (CIIR), chlorinated polyethylene (CPE), chlorosulfonated polyethylene (CSM), alkylated chlorosulfonated polyethylene (ACSM), polyepichlorohydrin rubbers (CO; ECO; ETER), ethylene-vinyl acetate rubber (EVA), acrylate rubber (ACM), ethylene-acrylate rubber (AEM), silicone rubber (MQ, VMQ, PVMQ, FVMQ), fluorine rubber (FKM), fluorinated methylsilicone rubber (MFQ), perfluorinated propylene rubber (FFPM), perfluorocarbon rubber (FFKM), thermoplastic elastomers (TPE), thermoplastic vulcanizates (TPV), thermoplastic polyurethanes (TPU), polyolefin elastomers (POE), polyvinylchloride (PVC), and/or polyurethane (PU), and/or the like, or blends thereof.

The composition other than the exemplary elastomeric composition that forms a layer of the article may further include various additives of suitable types and amounts, such as those described above for elastomeric layer, which may include, but is not limited to, pigments and/or dyes to provide a color, retardants, antioxidants, vulcanizing agents, cure accelerators or other processing aids, reinforcing agents and fillers, such as carbon black, silica, other mineral fillers (e.g., calcium carbonate, talc, etc.), or the like. As an example, reinforcing fillers may be provided in a broad range from about 20 phr to about 700 phr, including for example carbon black from about 200 phr to about 400 phr; and plasticizers such as oils may be provided in a range from about 10 phr to about 200 phr.

Exemplary compositions and articles have been described herein in which one or more polychloroprene elastomer(s) are curable by a sustainable vulcanizing agent, more particularly in which the sustainable vulcanizing agent is at least partially derived from a sustainable source of treated dregs.

According to an aspect, an elastomeric composition comprises: one or more polychloroprene elastomer(s); and a sustainable vulcanizing agent adapted to cure the one or more polychloroprene elastomer(s), the sustainable vulcanizing agent being at least partially derived from a sustainable source.

According to another aspect, an article comprises: at least one layer formed from an elastomeric composition comprising: one or more polychloroprene elastomer(s); and a sustainable vulcanizing agent adapted to cure the one or more polychloroprene elastomer(s), the sustainable vulcanizing agent being at least partially derived from a sustainable source of treated dregs, and having a composition comprising, in % by mass based on the sustainable vulcanizing agent: 25%-50% CaO, 2% to 20% MgO, and 20% to 40% ZnO.

According to another aspect, an elastomer-making process, comprises the steps: providing an elastomeric mixture comprising one or more polychloroprene elastomer(s); and adding a sustainable vulcanizing agent to the elastomeric mixture, wherein the sustainable vulcanizing agent is adapted to cure the one or more polychloroprene elastomer(s), the sustainable vulcanizing agent being at least partially derived from a sustainable source of treated dregs, and having a composition comprising, in % by mass based on the sustainable vulcanizing agent: 25%-50% CaO, 2% to 20% MgO, and 20% to 40% ZnO.

According to another aspect, a multilayer hose comprises: an inner tube layer; a reinforcement layer disposed outwardly from the inner tube layer; and an outer cover layer disposed outwardly from the reinforcement layer; wherein at least one of the inner tube layer, the reinforcement layer, and the outer cover layer is formed from an elastomeric composition comprising: one or more polychloroprene elastomer(s); and a sustainable vulcanizing agent adapted to cure the one or more polychloroprene elastomer(s), the sustainable vulcanizing agent being at least partially derived from a sustainable source of treated dregs, and having a composition comprising, in % by mass based on the sustainable vulcanizing agent: 25%-50% CaO, 2% to 20% MgO, and 20% to 40% ZnO.

Exemplary embodiment(s) may include one or more of the following additional features combined with any of the foregoing or following aspects, in which one or more of these additional features may be combined separately or in any suitable combination with each other.

In exemplary embodiment(s), the composition of the sustainable vulcanizing agent comprises, in % by mass based on the sustainable vulcanizing agent: 25% to 35% CaO, 5% to 15% MgO, and 25% to 35% ZnO.

In exemplary embodiment(s), the sustainable vulcanizing agent is present in an amount from 1 phr to 10 phr.

In exemplary embodiment(s), the sustainable vulcanizing agent is present in an amount from 3 phr to 8 phr.

In exemplary embodiment(s), the polychloroprene elastomer(s) are present in the elastomeric composition in a total amount of 100 phr.

In exemplary embodiment(s), the polychloroprene elastomer(s) include G-type elastomer(s) present in a total amount of 100 phr.

In exemplary embodiment(s), the polychloroprene elastomer(s) include W-type elastomer(s) present in a total amount of from 75 phr to 100 phr.

In exemplary embodiment(s), the sustainable vulcanizing agent is the only vulcanizing agent in the elastomeric composition.

In exemplary embodiment(s), the polychloroprene elastomer(s) consist of G-type chloroprene elastomer(s), and the elastomeric composition contains no accelerator(s).

In exemplary embodiment(s), the polychloroprene elastomer(s) consist of W-type chloroprene elastomer(s), and the elastomeric composition comprises one or more accelerators accelerator(s) in a total amount from 1 phr to 8 phr.

In exemplary embodiment(s), the composition of the sustainable vulcanizing agent further comprises, in % by mass based on the sustainable vulcanizing agent: Loss on Ignition (LOI): 35 to 45; SO₂: 0.5 to 2.0; Al₂O₃: 0.5 to 1.5; Fe₂O₃: 0.5 to 1.5; TiO₂: 0.0 to 1.0; K₂O: 0.0 to 1.0: Na₂O: 0.5 to 5.0; P₂O₅: 0.2 to 1.5; BaO: 0.0 to 02: SrO: 0.0 to 0.5; MnO: 0.1 to 2.0; and SO₃: 0.5 to 5.0.

In exemplary embodiment(s), the treated dregs are derived from cellulose production residue.

In exemplary embodiment(s), the elastomeric composition further comprises one or more reinforcing agent(s) in a total amount from 30 phr to 100 phr.

In exemplary embodiment(s), the elastomeric composition further comprises one or more plasticizer(s) in a total amount from 1 phr to 20 phr.

In exemplary embodiment(s), the elastomeric composition further comprises one or more acid receptor(s) in a total amount from 1 phr to 10 phr.

In exemplary embodiment(s), the elastomeric composition further comprises one or more antidegradant(s) in a total amount from 1 phr to 15 phr.

In exemplary embodiment(s), the elastomeric composition exhibits about the same tensile, modulus, hardness, tear strength, and/or abrasion resistance as a same comparative elastomeric composition using zinc oxide only as the vulcanizing agent instead of the sustainable vulcanizing agent, in which the zinc oxide is present in the comparative composition as a 1:1 replacement of the sustainable vulcanizing agent.

In exemplary embodiment(s), the elastomeric composition exhibits about the cure behavior as a same comparative elastomeric composition using zinc oxide only as the vulcanizing agent instead of the sustainable vulcanizing agent, in which the zinc oxide is present in the comparative composition as a 1:1 replacement of the sustainable vulcanizing agent.

In exemplary embodiment(s), the article is a layer of a hose, a belt, a bellows, a damper, a seal, or a gasket.

In exemplary embodiment(s), the process further comprising the step of forming the elastomeric mixture into an uncured article, more particularly an uncured hose, belt, bellows, damper, seal, or gasket.

The foregoing description of the embodiments has been provided for purposes of illustration and description. Example embodiments are provided so that this disclosure will be sufficiently thorough, and will convey the scope to those who are skilled in the art. Numerous specific details are set forth such as examples of specific components, devices, and methods, to provide a thorough understanding of embodiments of the disclosure, but are not intended to be exhaustive or to limit the disclosure. It will be appreciated that it is within the scope of the disclosure that individual elements or features of a particular embodiment are generally not limited to that particular embodiment, but, where applicable, are interchangeable and can be used in a selected embodiment, even if not specifically shown or described. Thus, while a particular feature may have been described with respect to only one or more of several embodiments, such feature may be combined with one or more other features of the other embodiments, separately or in any combination. The same may also be varied in many ways. Such variations are not to be regarded as a departure from the disclosure, and all such modifications are intended to be included within the scope of the disclosure. as may be desired and advantageous for any given or particular application.

Any background information contained in this disclosure is to facilitate a better understanding of the various aspects described herein. It should be understood that any such background statements are to be read in this light, and not as admissions of prior art. Likewise, the description and examples are presented herein solely for the purpose of illustrating the various embodiments of the disclosure and should not be construed as a limitation to the scope and applicability of the disclosure.

The phrase “and/or” as used in this disclosure should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

The word “or” as used in this disclosure should be understood as being inclusive and not exclusive. For example, when separating items in a list, “or” or “and/or” shall be interpreted as being inclusive, i.e., the inclusion of at least one, but also including more than one, of a number or list of elements, and, optionally, additional unlisted items. For example, a condition A or B is satisfied by anyone of the following: A is true (or present) and B is false (or not present), A is false (or not present) and B is true (or present), and both A and B are true (or present). Only terms clearly indicating exclusivity should be interpreted as indicating exclusive alternatives (i.e. “one or the other but not both”), such as “either,” “only one of,” or “exactly one of.” In other words, such terms of exclusivity refer to the inclusion of exactly one element of a number or list of elements.

Any references to “one embodiment” or “an embodiment” as used herein is understood to mean that a particular element, feature, structure, or characteristic described in connection with the embodiment is included in at least one embodiment. The appearances of the phrase “in one embodiment” in various places in the specification are not necessarily referring to the same embodiment.

In addition, use of the “a” or “an” are employed to describe elements and components of the embodiments herein. This is done merely for convenience and to give a general sense of concepts according to the disclosure. This description should be read to include one or at least one and the singular also includes the plural unless otherwise stated.

The word “exemplary” is used herein to mean “serving as an example or illustration.” Any aspect or design described herein as “exemplary” is not necessarily to be construed as preferred or advantageous over other aspects or designs. Likewise, the phrases “particularly,” “preferably,” or the like as used in this disclosure may refer to an element or value that provides advantage(s) in some embodiment(s), however is not intended to limit the scope of the disclosure to those “particular” or “preferable” features.

Transitional language such as “including,” “comprising,” “having,” “containing,” “involving,” or variations thereof, is intended to be broad and encompass the subject matter listed thereafter, equivalents, and additional subject matter not recited, i.e., to be open-ended and meaning including but not limited to.

It is to be understood that terms such as “top,” “bottom,” “upper,” “lower,” “left,” “right,” “front,” “rear,” “forward,” “rearward,” or the like may refer to an arbitrary frame of reference, rather than to the ordinary gravitational frame of reference.

It is to be understood that all values, ranges, ratios or the like as described in this disclosure may be combined in any manner. In addition, it is to be understood that a concentration or amount or value range listed in this disclosure is intended to include any and every concentration or amount or value within the range, including the end points, as if each value within the range has been expressly stated. For example, “a range of from 1 to 10” is to be read as indicating each and every possible number along the continuum between about 1 and about 10. Thus, even if specific data points within the range, or even no data points within the range, are explicitly identified or refer to only a few specific data points, it is to be understood that the inventor(s) appreciate and understand that any and all data points within the range are to be considered to have been specified, and that inventor(s) had possession of the entire range and all points within the range.

In addition, each numerical value used in this disclosure should be read once as modified by the term “about” (unless already expressly so modified), and then read again as not so modified unless otherwise indicated in context. The term “about” as used herein refers to any value which lies within the range defined by a variation of up to ±10% of the stated value, for example, ±10%, ±9%, ±8%, ±7%, ±6%, ±5%, ±4%, ±3%, ±2%, ±1%, ±0.01%, or ±0.0% of the stated value, as well as values intervening such stated values. When the term “about” is used in describing a value or an end-point of a range, the disclosure should be understood to include the specific value or end-point referred to.

The term “consisting essentially of” in relation to a composition is to indicate that substantially (e.g., greater than 95 weight % or greater than 99 weight %) of the component(s) present in the composition is the component(s) recited. Therefore, this term does not exclude the presence of minor additives or impurities as would be understood by those having ordinary skill in the art.

Although the invention has been shown and described with respect to a certain embodiment or embodiments, it is apparent that equivalent alterations and modifications will occur to those having ordinary skill in the art upon the reading and understanding this disclosure, and such modifications are intended to be included within the scope of this disclosure as defined in the claims. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the disclosure.

1. A multilayer hose comprising:
an inner tube layer;
a reinforcement layer disposed outwardly from the inner tube layer; and
an outer cover layer disposed outwardly from the reinforcement layer;
wherein at least one of the inner tube layer, the reinforcement layer, and the outer cover layer is formed from an elastomeric composition comprising:
one or more polychloroprene elastomer(s); and
a sustainable vulcanizing agent adapted to cure the one or more polychloroprene elastomer(s), the sustainable vulcanizing agent being at least partially derived from a sustainable source of treated dregs, and having a composition comprising, in % by mass based on the sustainable vulcanizing agent: 25%-50% CaO, 2% to 20% MgO, and 20% to 40% ZnO.

2. The multilayer hose according to claim 1, wherein:
the composition of the sustainable vulcanizing agent comprises, in % by mass based on the sustainable vulcanizing agent: 25% to 35% CaO, 5% to 15% MgO, and 25% to 35% ZnO.

3. The multilayer hose according to claim 1,
the sustainable vulcanizing agent is present in an amount from 1 phr to 10 phr.

4. The multilayer hose according to claim 1, wherein:
the sustainable vulcanizing agent is present in an amount from 3 phr to 8 phr.

5. The multilayer hose according to claim 1, wherein:
the polychloroprene elastomer(s) are present in the elastomeric composition in a total amount of 100 phr.

6. The multilayer hose according to claim 1, wherein:
the sustainable vulcanizing agent is the only vulcanizing agent in the elastomeric composition.

7. The multilayer hose according to claim 1, wherein:
the polychloroprene elastomer(s) consist of G-type chloroprene elastomer(s), and the elastomeric composition contains no accelerator(s).

8. The multilayer hose according to claim 1, wherein:
the polychloroprene elastomer(s) consist of W-type chloroprene elastomer(s), and the elastomeric composition comprises one or more accelerators accelerator(s) in a total amount from 1 phr to 8 phr.

9. The multilayer hose according to claim 1, wherein:
the composition of the sustainable vulcanizing agent further comprises, in % by mass based on the sustainable vulcanizing agent:
Loss on Ignition (LOI): 35 to 45;
SiO₂: 0.5 to 2,0;
Al₂O₃: 0.5 to 1.5;
Fe₂O₃: 0.5 to 1.5;
TiO₂: 0.0 to 1.0;
K₂O: 0.0 to 1.0;
Na₂O: 0.5 to 5.0;
P₂O₅: 0.2 to 1.5;
BaO: 0.0 to 0.2;
SrO: 0.0 to 0.5;
MnO: 0.1 to 2.0; and
SO₃: 0.5 to 5.0.

10. The multilayer hose according to claim 1, wherein:
the treated dregs are derived from cellulose production residue.

11. The multilayer hose according to claim 1, wherein:
the elastomeric composition further comprises:
one or more reinforcing agent(s) in a total amount from 30 phr to 100 phr;
one or more plasticizer(s) in a total amount from 1 phr to 20 phr;
one or more acid receptor(s) in a total amount from 1 phr to 10 phr; and
one or more antidegradant(s) in a total amount from 1 phr to 15 phr.

12. The multilayer hose according to claim 1, wherein:
the elastomeric composition exhibits about the same tensile, modulus, hardness, tear strength, and/or abrasion resistance as a same comparative elastomeric composition using zinc oxide only as the vulcanizing agent instead of the sustainable vulcanizing agent, in which the zinc oxide is present in the comparative composition as a 1:1 replacement of the sustainable vulcanizing agent.

13. The multilayer hose according to claim 1, wherein:
the elastomeric composition exhibits about the cure behavior as a same comparative elastomeric composition using zinc oxide only as the vulcanizing agent instead of the sustainable vulcanizing agent, in which the zinc oxide is present in the comparative composition as a 1:1 replacement of the sustainable vulcanizing agent.

14. An article comprising:
at least one layer formed from an elastomeric composition comprising:
one or more polychloroprene elastomer(s); and
a sustainable vulcanizing agent adapted to cure the one or more polychloroprene elastomer(s), the sustainable vulcanizing agent being at least partially derived from a sustainable source of treated dregs, and having a composition comprising, in % by mass based on the sustainable vulcanizing agent: 25%-50% CaO, 2% to 20% MgO, and 20% to 40% ZnO.

15. The article according to claim 14, wherein the elastomeric layer is a layer of a hose, a belt, a bellows, a damper, a seal, or a gasket.

16. (canceled)

17. An elastomer-making process, comprising steps:
providing an elastomeric mixture comprising one or more polychloroprene elastomer(s); and
adding a sustainable vulcanizing agent to the elastomeric mixture, wherein the sustainable vulcanizing agent is adapted to cure the one or more polychloroprene elastomer(s), the sustainable vulcanizing agent being at least partially derived from a sustainable source of treated dregs, and having a composition comprising, in % by mass based on the sustainable vulcanizing agent: 25%-50% CaO, 2% to 20% MgO, and 20% to 40% ZnO.

18. The process according to claim 17 further comprising the step of forming the elastomeric mixture into an uncured article, the uncured article being an uncured hose, belt, bellows, damper, seal, or gasket.

19. The process according to claim 17, further comprising vulcanizing the article.

20. (canceled)

21.-24. (canceled)
